(19) United States
(12) Patent Application Publication
(10) Pub. No.: US 2020/0195021 A1
(43) Pub. Date: Jun. 18, 2020

(54) CHARGING SYSTEM AND CHARGING METHOD

(71) Applicant: SZ DJI TECHNOLOGY CO., LTD., Shenzhen (CN)

(72) Inventors: Jingang HU, Shenzhen (CN); Tao ZHAO, Shenzhen (CN); Jie TIAN, Shenzhen (CN)

(21) Appl. No.: 16/802,964

(22) Filed: Feb. 27, 2020

Related U.S. Application Data
(63) Continuation of application No. PCT/CN2017/099346, filed on Aug. 28, 2017.

(51) Int. Cl. H02J 7/00

(52) U.S. Cl. CPC H02J 7/0018; H02J 7/00041; B64C 2201/066; H02J 7/00309; H02J 7/0019

(57) ABSTRACT

A charging method includes obtaining electrical parameter information of a charging circuit configured to charge one or more batteries, and controlling the charging circuit to selectively charge the one or more batteries and/or to charge an external device according to the electrical parameter information of the charging circuit.

### CROSS-REFERENCE TO RELATED APPLICATION

This application is a continuation of International Application No. PCT/CN2017/099346, filed on Aug. 28, 2017, the entire content of which is incorporated herein by reference.

### TECHNICAL FIELD

The present disclosure relates to unmanned aerial vehicle field and, more particularly, to a charging system and a charge method.

### BACKGROUND

In the existing technology, batteries are used as a power source for an unmanned aerial vehicle (UAV). When battery power is reduced to a certain level, the batteries need to be charged. Usually, a charger is used to charge the batteries, with one battery being charged after another battery is fully charged. When the batteries need to be frequently exchanged for the UAV, a longer battery charging time is required.

Further, the chargers of devices are used individually in the existing technology, for example, an aircraft adapter, an aircraft battery manager, a remote controller charger, a battery-power bank converter, etc., are used individually, so that the battery of the UAV, a remote controller, a photographing device, etc., need to be charged individually, such that the efficiency of the UAV is reduced.

### SUMMARY

In accordance with the disclosure, there is provided a charging method including obtaining electrical parameter information of a charging circuit configured to charge one or more batteries, and controlling the charging circuit to selectively charge the one or more batteries and/or to charge an external device according to the electrical parameter information of the charging circuit.

### BRIEF DESCRIPTION OF THE DRAWINGS

FIG. 1 is a structural diagram of a charging system according to an embodiment of the disclosure.

FIG. 2 is a structural diagram of a charging system according to another embodiment of the disclosure.

FIG. 3 is a structural diagram of a charging system according to another embodiment of the disclosure.

FIG. 4 is a structural diagram of a battery control system according to an embodiment of the disclosure.

FIG. 5 is a structural diagram of a charging system according to another embodiment of the disclosure.

FIG. 6 is a structural diagram of a charging system according to another embodiment of the disclosure.

FIG. 7 is a flowchart of a charging method according to an embodiment of the disclosure.

FIG. 8 is a flowchart of a charging method according to another embodiment of the disclosure.

FIG. 9 is a flowchart of a charging method according to another embodiment of the disclosure.

Reference numerals:

| | | |
|---|---|---|
| 111 - first charging | 112 - processor; | 113 - adapter |
| interface; | | |
| 114 - heat dissipation | 115 - discharge resistor; | 116 - first output |
| device; | | interface; |
| 117 - second output | 118 - second charging | 119 - display device; |
| interface; | interface; | |
| 200 - USB interface; | 40 - battery; | 41 - switch. |

### DETAILED DESCRIPTION OF THE EMBODIMENTS

Technical solutions of the present disclosure will be described with reference to the drawings. The described embodiments are only some of the embodiments not all the embodiments of the present disclosure. Based on the embodiments of the disclosure, all other embodiments obtained by those of ordinary skill in the art without any creative work are within the scope of the present disclosure.

When a component is referred to as “fixed to” another component, the component may be directly on the another component or there may be a component therebetween. When a component is referred to as “connected to” another component, the component may be directly connected to the another component or there may be a component therebetween.

All technical and scientific terms used herein have the same meaning as commonly understood by one of ordinary skill in the art, unless otherwise defined. The terminology used in the specification of the present disclosure is for the purpose of describing specific embodiments and is not intended to limit the disclosure. The term “and/or” as used herein includes any and all combinations of one or more of the associated listed items.

Some embodiments of the disclosure are described in detail with reference to the drawings. When no conflict, the features of the embodiments and the embodiments described below can be combined with each other.

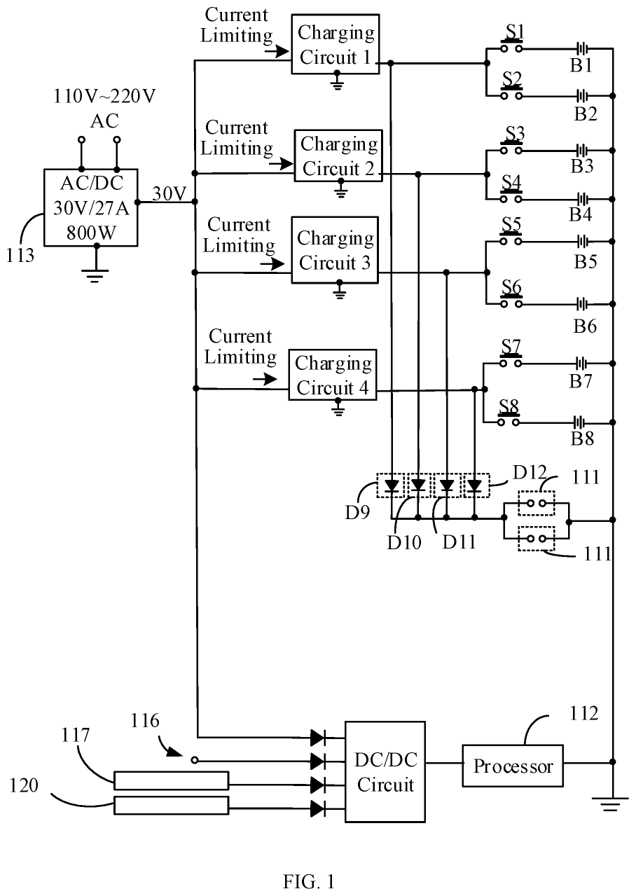

In accordance with the present disclosure, there is provided a charging system. FIG. 1 is a structural diagram of an example charging system consistent with embodiments of the disclosure. The charging system is suitable for simultaneously charging a plurality of batteries of a frequently operating UAV or a movable robot. While a plurality of batteries are being charged, the charging system may also charge external devices of the UAV or the movable robot, e.g., a remote device, a photographing device, etc. As shown in FIG. 1, the charging system includes at least one charging circuit, a first charging interface 111, one or more processors 112, and an adapter 113. As shown in FIG. 1, the at least one charging circuit includes charging circuit 1, charging circuit 2, charging circuit 3, or charging circuit 4. This description is merely illustrative and does not limit the number of the charging circuits. Each charging circuit charges at least one battery. As shown in FIG. 1, charging circuit 1 charges battery B1 and battery B2, charging circuit 2 charges battery B3 and battery B4, charging circuit 3 charges battery B5 and battery B6, and charging circuit 4 charges battery B7 and B8. In the present embodiment, each charging circuit can charge two batteries. The description here is merely illustrative and does not limit the number of the batteries that each charging circuit can charge.

In some embodiments, each battery is electrically connected through a first switch to the charging circuit that charges the battery. When the processor controls the charging circuit to selectively charge at the least one battery connected to the charging circuit, the processor can control the at least one switch connected to the charging circuit to close, so that the charging circuit can charge the at least one battery connected to the charging circuit. As shown in FIG. 1, battery B1 is electrically connected to charging circuit 1 through switch S1, and battery B2 is electrically connected to charging circuit 1 through switch S2, battery B3 is electrically connected to charging circuit 2 through switch S3, battery B4 is electrically connected to charging circuit 2 through switch S4, battery B5 is electrically connected to charging circuit 3 through switch S3, battery B6 is electrically connected to charging circuit 3 through switch S6, battery B7 is electrically connected to charging circuit 4 through switch S7, and battery B8 is electrically connected to charging circuit 4 through switch S8. The processor 112 controls switch S1 to close for charging circuit 1 to charge battery B1, controls switch S2 to close for charging circuit 1 to charge battery B2, controls switch S3 to close for charging circuit 2 to charge battery B3, controls switch S4 to close for charging circuit 2 to charge battery B4, controls switch S5 to close for charging circuit 3 to charge battery B5, controls switch S6 to close for charging circuit 3 to charge battery B6, controls switch S7 to close for charging circuit 4 to charge battery B7, or controls switch S8 to close for charging circuit 4 to charge battery B8. Switches S1-S8 may be mechanical relays or back-to-back p-channel metal oxide semiconductor (PMOS) field-effect transistors.

The first charging interface 111 is connected to each of the charging circuits and is configured to charge a first external device. As shown in FIG. 1, the first charging interface 111 is connected to charging circuit 1, charging circuit 2, charging circuit 3, and charging circuit 4. In some embodiments, each charging circuit is electrically connected to the first charging interface 111 through a first unidirectional device. An input terminal of the first unidirectional device is electrically connected to the charging circuit, and an output terminal of the first unidirectional device is electrically connected to the first charging interface. The first unidirectional device includes a diode. As shown in FIG. 1, charging circuit 1 is electrically connected to the first charging interface 111 through diode D9, charging circuit 2 is electrically connected to the first charging interface 111 through diode D10, charging circuit 3 is electrically connected to the first charging interface 111 through diode D11, and charging circuit 4 is electrically connected to the first charging interface 111 through diode D12. The input terminal of diode D9 is electrically connected to charging circuit 1, and the output terminal of diode D9 is electrically connected to the first charging interface 111. The input terminal of diode D10 is electrically connected to charging circuit 2, and the output terminal of diode D10 is electrically connected to the first charging interface 111. The input terminal of diode D11 is electrically connected to charging circuit 3, and the output terminal of diode D11 is electrically connected to the first charging interface 111. The input terminal of diode D12 is electrically connected to charging circuit 4, and the output terminal of diode D12 is electrically connected to the first charging interface 111.

In the present embodiment, the first external device includes at least one of a remote device of the UAV or a photographing device. The photographing device can be carried by the UAV. One or more of batteries B1-B8 may be a power source of the UAV. When battery power of the UAV decreases to a certain level, the batteries of the UAV need to be charged. While the batteries are being charged, the charging system can also charge the external device of the UAV.

As shown in FIG. 1, the AC-to-DC converting (simply denoted as “AC/DC”) adapter 113 converts an alternating current (AC) power of 110V-220V a 30V direct current (DC) power with an output current of 27 A and a nominal output power of 800 W. In the present embodiment, charging circuit 1, charging circuit 2, charging circuit 3, and charging circuit 4 specifically can be four DC charging circuits. In some other embodiments, charging circuit 1, charging circuit 2, charging circuit 3, and charging circuit 4 may also be four DC chargers. The 30V DC power output by the adapter 113 is stepped down by the four DC charging circuits first with constant current then with constant voltage, and is then provided to charge the batteries. When the DC charging circuits charge the batteries with constant currents, the output currents by the DC charging circuits are constant. In the present embodiment, the processor 112 can also adjust the magnitudes of the constant currents output by the DC charging circuits. For example, the processor 112 controls the magnitude of the currents according to battery temperatures when the DC charging circuits charge the batteries.

The processor 112 may be a general purpose or special purpose processor. The one or more processors 112 are electrically connected to each charging circuit, i.e., each of charging circuit 1, charging circuit 2, charging circuit 3, and charging circuit 4. The processor 112 is configured to obtain electrical parameter information of the charging circuits, and control each charging circuit to selectively charge at least one battery connected to the charging circuit according to the electrical parameter information of the charging circuit, and/or charge the first external device connected to the first charging interface. The processor 112 may be a micro controller unit (MCU)

When the processor controls each charging circuit to selectively charge at least one battery connected to the charging circuit, the processor is configured to control each charging circuit to charge at least one battery first with constant current then with constant voltage. In some embodiments, taking charging circuit 1 as an example, the processor 112 can control charging circuit 1 to charge at least one of battery B1 or battery B2 first with constant current then with constant voltage. Similarly, the processor 112 can also control charging circuit 2 to charge at least one of battery B3 or battery B4 first with constant current then with constant voltage, control charging circuit 3 to charge at least one of battery B5 or battery B6 first with constant current then with constant voltage, and control charging circuit 4 to charge at least one of battery B7 or B8 first with constant current then with constant voltage.

When the charging circuit starts to charge the at least one battery, the output current by the charging circuit is constant, so that the at least one battery is charged with the constant current. For example, when charging circuit 1 starts to charge battery B1, the output current by charging circuit 1 is constant, i.e., when charging circuit 1 starts to charge battery B1, charging circuit 1 charges battery B1 with the constant current, so that the power of battery B1 increases quickly. When the power of battery B1 increases to a preset power, the processor 112 can further control the output voltage of charging circuit 1 to be constant, i.e., control charging circuit 1 to charge battery B1 with the constant voltage.

In the present embodiment, the processor 112 can obtain the electrical parameter information of the charging circuits in real time. For example, the processor 112 can obtain the electrical parameter information of respective ones of charging circuit 1, charging circuit 2, charging circuit 3, or charging circuit 4 in real time. In some embodiments, the electrical parameter information of a charging circuits includes at least one of the output power of the charging circuit, the output current of the charging circuit, or the output voltage of the charging circuit. In some embodiments, the processor 112 can control each charging circuit to selectively charge the at least one battery connected to the charging circuit and/or the first external device connected to the first charging interface according to the electrical parameter information of the charging circuit. For example, the processor 112 controls charging circuit 1 to selectively charge at least one of battery B1 or battery B2, and/or the first external device connected to the charging interface 111, according to the electrical parameter information of charging circuit 1.

When the processor controls each charging circuit to selectively charge the at least one battery connected to the charging circuit, and/or the first external device connected to the first charging interface, the processor can, when the charging circuit switches from outputting the constant current to outputting the constant voltage, control the charging circuit to charge other one or more batteries and/or the first external device with the constant current simultaneously. For example, charging circuit 1 first charges battery B1 with the constant current, and when the power of battery B1 increases to the preset power, charging circuit 1 switches to output the constant voltage to charge battery B1. When the charging mode of battery B1 switches from the constant current charging mode to the constant voltage charging mode, the charging current for battery B1 from charging circuit 1 decreases. The part of the decreased current can be used to charge battery B2, be used to charge the first external device connected to the first charging interface 111, or be used to charge both battery B2 and the first external device connected to the first charging interface 111. In some embodiments, when the charging mode of battery B1 switches from the constant current charging mode to the constant voltage charging mode, the processor 112 can control charging circuit 1 to charge battery B1 with a constant voltage, and at the same time charge battery B2 and/or the first external device connected to the first charging interface 111 with a constant current. When the charging mode of battery B2 switches from the constant current charging mode to the constant voltage charging mode, the charging current for battery B2 from charging circuit 1 decreases. The part of the decreased current can be used to charge the first external device connected to the first charging interface 111, or be output to charging circuit 2. Charging circuit 2 can charge battery B3 and battery B4 by combining the saved current from charging circuit 1 and the original current of charging circuit 2. The charging method for charging circuit 2 to charge battery B3 and battery B4 is similar to the charging method for charging circuit 1 to charge battery B1 and battery B2, which is not described here. Charging circuit 2 can charge battery B3 and battery B4, and at the same time charge the first external device connected to the first charging interface 111. The charging processes for charging circuit 3 and charging circuit 4 can be similar to above and are not described here.

In some embodiments, the processor 112 is configured to detect the remaining power of the at least one battery connected to the charging circuit. When the at least one battery is fully charged, the processor 112 controls the charging circuit to charge the first external device connected to the first charging interface. For example, when charging circuit 1 charges battery B1 and battery B2 with a constant voltage, battery B1 and battery B2 may not be fully charged, and charging circuit 1 still needs to charge battery B1 and battery B2 for a certain time with the constant voltage before battery B1 and battery B2 are fully charged. In this scenario, the processor 112 can detect the remaining powers of battery B1 and battery B2 in real time. When the processor 112 determines that both battery B1 and battery B2 are fully charged according to the remaining powers of battery B1 and battery B2, the processor 112 controls charging circuit 1 to charge the first external device connected to the first charging interface 111. When charging circuit 2 fully charges battery B3 and battery B4, the processor 112 controls charging circuit 2 to charge the first external device connected to the first charging interface 111. When charging circuit 3 fully charges battery B5 and battery B6, the processor 112 controls charging circuit 3 to charge the first external device connected to the first charging interface 111. When charging circuit 4 fully charges battery B7 and battery B8, the processor 112 controls charging circuit 4 to charge the first external device connected to the first charging interface 111.

In some embodiments, when the AC power is converted to DC power by the adapter, and a plurality of charging circuits charge a plurality of batteries at the same time using the DC power first with constant current then with constant voltage, if the first charging interface 111 is connected to the first external device, a part of the DC power is separated from a plurality of charging circuits to charge the first external device, and the charging currents for the batteries decrease. If the first charging interface 111 is not connected to any first external device, the batteries are charged with the maximum power.

In the present embodiment, a plurality of batteries are charged by a plurality of charging circuits simultaneously, and the charging time is reduced. In some embodiments, the processor of the charging system controls the plurality of charging circuits to selectively charge the plurality of batteries and/or external devices according to the electrical parameter information of the charging circuits, so that the plurality of charging circuits can charge the plurality of batteries and at the same time can charge the external devices, e.g., a remote device of the UAV, the photographing device, etc., and the efficiency of the UAV is improved.

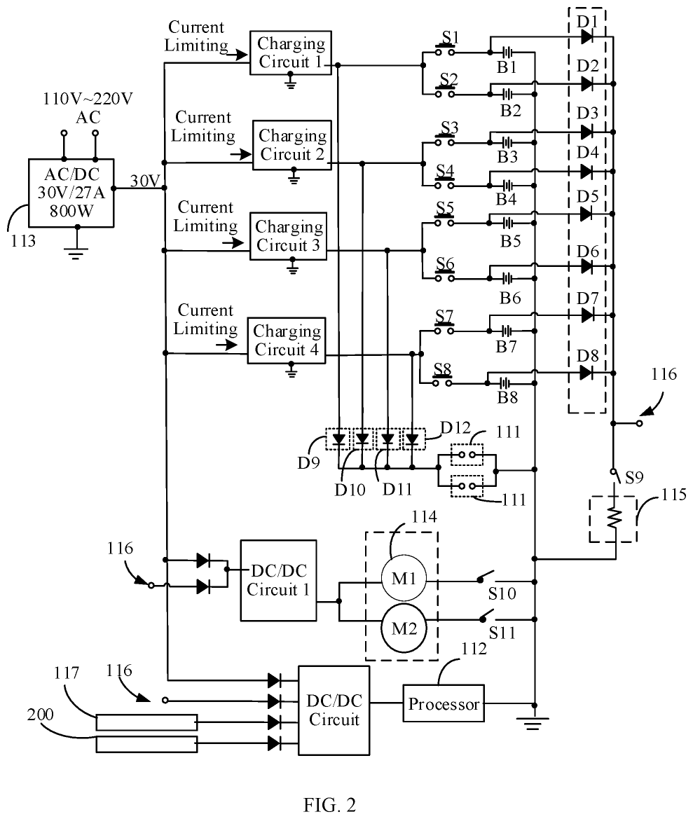

In accordance with the present disclosure, there is provided a charging system. FIG. 2 is a structural diagram of another example charging system consistent with embodiments of the disclosure. Based on the embodiments descried above in connection with FIG. 1, the charging system shown in FIG. 2 further includes at least one of a second unidirectional device, and each second unidirectional device is connected to a battery and is configured to connect each battery in parallel. In the present embodiment, the second unidirectional device includes a diode. As shown in FIG. 2, diode D1 is connected to a junction between switch S1 and battery B1, diode D2 is connected to a junction between switch S2 and battery B2, diode D3 is connected to a junction between switch S3 and battery B3, diode D4 is connected to a junction between switch S4 and battery B4, diode D5 is connected to a junction between switch S5 and battery B5, diode D6 is connected to a junction between switch S6 and battery B6, diode D7 is connected to a junction between switch S7 and battery B7, and diode D8 is connected to a junction between switch S8 and battery B8. Diodes D1-D8 connect batteries B1-B8 in parallel. In some other embodiments, the second unidirectional diode can be a traditional diode.

In addition, as shown in FIG. 2, the charging system also includes a heat dissipation device 114 and a discharge resistor 115. A positive terminal of each battery is electrically connected to the input terminal of a second unidirectional device, the output terminal of each second unidirectional device is electrically connected to the discharge resistor 115, and the output terminal of each second unidirectional device is electrically connected to the heat dissipation device 114. For example, the positive terminal of battery B1 is electrically connected to the input terminal of diode D1, the positive terminal of battery B2 is electrically connected to the input terminal of diode D2, the positive terminal of battery B3 is electrically connected to the input terminal of diode D3, the positive terminal of battery B4 is electrically connected to the input terminal of diode D4, the positive terminal of battery B5 is electrically connected to the input terminal of diode D5, the positive terminal of battery B6 is electrically connected to the input terminal of diode D6, the positive terminal of battery B7 is electrically connected to the input terminal of diode D7, and the positive terminal of battery B8 is electrically connected to the input terminal of diode D8. The output terminals of diodes D1-D8 are electrically connected to the discharge resistor 115. In some embodiments, the discharge resistor includes a positive temperature coefficient (PTC) thermistor. In some other embodiments, the discharge resistor 115 can be a conventional resistor. In addition, the output terminals of diodes D1-D8 are electrically connected to the heat dissipation device 114. In some embodiments, the heat dissipation device 114 includes a fan.

In some embodiments, the output terminal of each second unidirectional device is electrically connected to the discharge resistor through a second switch. As shown in FIG. 2, the output terminals of diodes D1-D8 are electrically connected to the discharge resistor 115 through second switch S9. The processor 112 is configured to control the second switch to close to discharge each battery through the discharge resistor. The processor 112 can control second switch S9 to close to discharge batteries B1-B8 through the discharge resistor 115, e.g., the positive temperature coefficient thermistor, and at the same time cool the charging system through the fan.

In some embodiments, the processor 112 is also configured to obtain the electrical parameter information of the batteries, determine if the batteries are abnormal according to the electrical parameter information of the batteries, and control the second switch to close to discharge the batteries through the discharge resistor if the batteries are abnormal. As shown in FIG. 2, since batteries B1-B8 are electrically connected individually to the processor 112, the processor 112 can obtain the electrical parameter information of each battery in real time, e.g., the powers of the batteries, lifetimes of the batteries, temperatures of the batteries, etc., and the processor 112 can determine if the batteries are abnormal according to the electrical parameter information of the batteries. For example, when the temperature of a battery is higher than a preset temperature threshold, the processor 112 determines that the battery is abnormal, so that the processor 112 can control second switch S9 to close to discharge batteries B1-B8 through the discharge resistor 115, e.g., the positive temperature coefficient thermistor, and at the same time cool the charging system through the fan.

In some embodiments, when the battery are discharged through the discharge resistor, the batteries can be used to charge the first external device connected to the first charging interface. As shown in FIG. 2, when batteries are discharged through the discharge resistor 115, the processor 112 can further control one or more of switches S1-S8 to close. In some embodiments, the processor 112 controls all switches S1-S8 to close. At this time, battery B1 and battery B2 will charge the first external device connected to the first charging interface 111 through diode D9, battery B3 and battery B4 will charge the first external device connected to the first charging interface 111 through diode D10, battery B5 and battery B6 will charge the first external device connected to the first charging interface 111 through diode D11, and battery B7 and battery B8 will charge the first external device connected to the first charging interface 111 through diode D12.

In some embodiments, when each battery is discharged through the discharge resistor, the processor is also configured to detect the remaining power of the battery, control the second switch to open to stop each battery from discharging when the remaining power of the battery is smaller than or equal to a first remaining power threshold. As shown in FIG. 2, when batteries B1-B8 start to be discharged through the discharge resistor 115, the battery with higher voltage is discharged first, and when the batteries B1-B8 have the same voltages, the batteries B1-B8 will be discharged at the same time. While batteries B1-B8 are being discharged, the processor 112 can also detect the remaining powers of the batteries. When the remaining power of each battery is smaller than or equal to the remaining power threshold, the processor 112 controls second switch S9 to open to stop batteries B1-B8 from discharging.

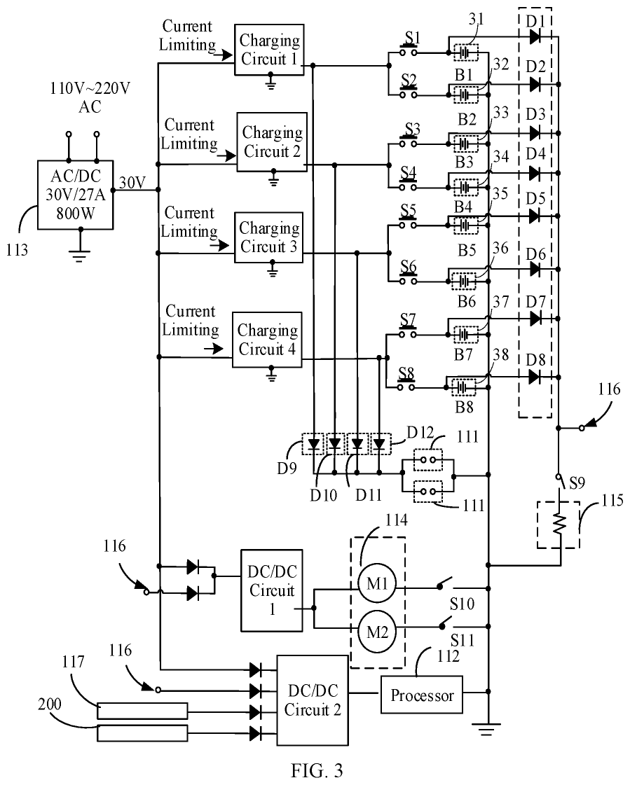

In some embodiments, each battery is placed in a battery case. As shown in FIG. 3, battery B1 is placed in a battery case 31 and the battery case 31 is electrically connected to switch S1 and diode D1, battery B2 is placed in a battery case 32 and the battery case 32 is electrically connected to switch S2 and diode D2, battery B3 is placed in a battery case 33 and the battery case 33 is electrically connected to switch S3 and diode D3, battery B4 is placed in a battery case 34 and the battery case 34 is electrically connected to switch S4 and diode D4, battery B5 is placed in a battery case 35 and the battery case 35 is electrically connected to switch S5 and diode D5, battery B6 is placed in a battery case 36 and the battery case 36 is electrically connected to switch S6 and diode D6, battery B7 is placed in a battery case 37 and the battery case 37 is electrically connected to switch S7 and diode D7, and battery B8 is placed in a battery case 38 and the battery case 38 is electrically connected to switch S8 and diode D8. In the present embodiment, the correspondence between the batteries and the battery cases may not be unique. For example, battery B1 can be placed in a battery case other than the battery case 31. Similarly, batteries B2-B8 can be placed in other battery cases. When switch S9 is closed, any battery of batteries B1-B8 can be discharged in any battery case.

As shown in FIG. 2 or FIG. 3, the charging system also includes a first output interface 116 configured to supply power to the charging system. The output terminal of each of the second unidirectional devices, e.g., second diodes D1-D8, is electrically connected to one terminal of the heat dissipation device 114 through the first output interface 116, and the other terminal of the heat dissipation device 114 is electrically connected to the processor 112 through third switches S10 and S11.

The heat dissipation device 114 may be a fan. When the batteries, e.g., batteries B1-B8, are discharged through the discharge resistor 115, the processor 112 can control third switches S10 and S11 to close to cool the charging system with the fan. In some embodiments, the processor 112 is configured to control the fan speed according to the electrical parameter information of the batteries. For example, the processor 112 controls the fan speed according to the battery temperature.

As shown in FIG. 2 or FIG. 3, the adapter 113 is connected to each of the charging circuits, e.g., charging circuits 1-4, and configured to convert the AC power to the DC power, such that charging circuits 1-4 charge at least one battery by using the DC power first with constant current then with constant voltage. While charging circuits 1-4 are charging batteries B1-B8, the adapter 113 supplies power to the charging system through the first output interface 116.

In some other embodiments, the charging system does not have the adapter 113. In the scenario without the adapter 113, batteries B1-B8 can also supply power to the charging system through the first output interface 116. While batteries B1-B8 are supplying power to the charging system, the processor 112 controls batteries B1-B8 to be discharged through the discharge resistor 115. In some embodiments, when each battery is discharged through the discharge resistor, each battery supplies power to the charging system through the first output interface. For example, in the scenario without the adapter 113, when batteries B1-B8 are discharged through the discharge resistor 115, batteries B1-B8 supply power to the charging system through the first output interface 116. For example, batteries B1-B8 supply power to DC-to-DC converting (simply denoted as “DC/DC”) circuit 1 through the first output interface 116, and DC/DC circuit 1 supplies power to the heat dissipation device 114. In some embodiments, batteries B1-B8 also supply power to DC/DC circuit 2 through the first output interface 116, and DC/DC circuit 2 supplies power to the processor 112.

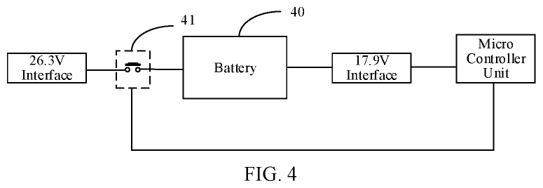

In some embodiments, before each battery supplies power to the charging system through the first output interface, each battery supplies power to the charging system through the second output interface to activate the charging system. In the present embodiment, each battery can have two output interfaces. As shown in FIG. 4, the battery 40 is any battery of batteries B1-B8. The battery 40 has two output interfaces. One output interface is a 17.9V interface, and the other output interface is a 26.3V interface. When the battery control system is not activated, the battery 40 supplies power to the micro controller unit of the battery control system through the 17.9V interface to activate the micro controller unit. After being activated, the micro controller unit controls the battery 40 to be electrically connected to the 26.3V interface. For example, the micro controller unit controls the switch 41 between the battery 40 and the 26.3V interface to close, so that the battery 40 supplies power through the 26.3V interface. In some embodiments, the first output interface 116 shown in FIG. 2 or FIG. 3 is the 26.3V interface of each battery, and a second output interface 117 shown in FIG. 2 or FIG. 3 is the 17.9V interface of each battery. Before batteries B1-B8 supply power to the charging system through the first output interface 116, batteries B1-B8 supply power to the charging system through the second output interface 117 to activate the charging system. After the charging system is activated, batteries B1-B8 supply power to the charging system through the first output interface 116.

As shown in FIG. 2 or FIG. 3, the adapter 113 supplies power to the charging system, and batteries B1-B8 supply power to the charging system through the first output interface 116 or the second output interface 117. When the adapter 113 does not supply power to the charging system and batteries B1-B8 do not supply power to the charging system, the USB interface 200 can be used to supply power to the charging system to ensure that the processor 112 is always powered on.

In the present embodiment, by discharging the batteries through the discharge resistor and at the same time controlling the fan to cool the charging system, the cooling power of the charging system is improved and the battery discharging time is reduced, so that the problem of battery being discharged before storage and transportation is solved. In some embodiments, the discharge resistor is a positive temperature coefficient thermistor. The temperature of the positive temperature coefficient thermistor stays stable after the temperature of the positive temperature coefficient thermistor reaches the maximum temperature, and the risk of heat accumulation is prevented. With a plurality of batteries parallelly connected through a plurality of diodes and a plurality of batteries connected in parallel discharged through a positive temperature coefficient thermistor, the number of positive temperature coefficient thermistors and the cost are reduced.

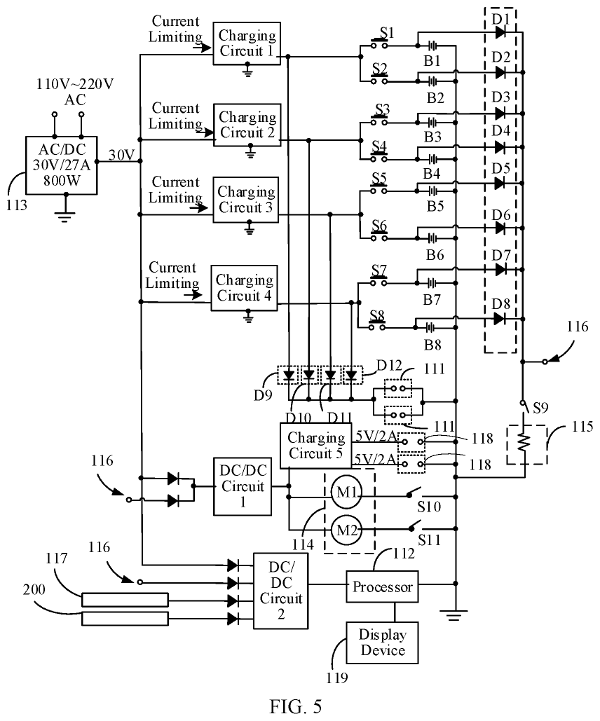

In accordance with the present disclosure, there is provided a charging system. FIG. 5 is a structural diagram of another example charging system consistent with embodiments of the present disclosure. Based on the embodiment above, e.g., based on the embodiments described above in connection with FIG. 2, the charging system shown in FIG. 5 further includes a second charging interface 118 electrically connected to the first output interface 116 and configured to charge a second external device. The second external device includes a user terminal device. As shown in FIG. 5, the second charging interface 118 is electrically connected to the first output interface 116 through DC/DC circuit 1 and charging circuit 5. In some embodiments, the charging circuit 5 may be a USB charger. In some embodiments, the second charging interface 118 may include two USB interfaces. When the second charging interface 118 is connected to the second external device, the method for the charging system to charge the second external device may include the following situations.

One possible situation is when each battery is discharged through the discharge resistor, each battery charges the second external device connected to the second charging interface through the first output interface.

For example, batteries B1-B8 are discharged through the discharge resistor 115, at the same time batteries B1-B8 supply power through the first output interface 116, in other words, batteries B1-B8 supply power to the charging system through the first output interface 116. In some embodiments, batteries B1-B8 supply power to DC/DC circuit 1 through the first output interface 116, DC/DC circuit 1 supplies power to charging circuit 5, and charging circuit 5 further charges the second external device connected to the second charging interface 118.

Another situation may be when the adapter supplies power to the charging system through the first output interface, the adapter charges the second external device connected to the second charging interface through the first output interface.

While the adapter 113 charges batteries B1-B8 through charging circuits 1-4, the adapter 113 can also supply powers through diodes D1-D8. In some embodiments, the adapter 113 is connected to the first output interface 116 through diodes D1-D8. The adapter 113 supplies power to the first output interface 116, the first output interface 116 supplies power to DC/DC circuit 1, DC/DC circuit 1 supplies power to charging circuit 5, and charging circuit 5 charges the second external device connected to the second charging interface 118.

In the present embodiment, when the adapter 113 supplies power to the charging system or batteries B1-B8 supply power to the charging system, the second charging interface 118 can output 5V voltage and 2 A current. The 5V voltage and 2 A current can charge the second external device connected to the second charging interface 118.

In some other embodiments, the user terminal device may be connected to the first charging interface 111, the remote device or the photographing device may be connected to the second charging interface 118, or the remote device is connected to the first charging interface 111 and the photographing device is connected to the second charging interface 118. In other words, the present embodiment does not limit the external devices connected to the first charging interface 111 and the external devices connected to the second charging interface 118.

As shown in FIG. 5, the charging system also includes a display device 119, which includes an LCD screen. The display device 119 is electrically connected to the processor 112, and the display device 119 is configured to display the electrical parameter information of batteries B1-B8 obtained by the processor 112. In some embodiments, when the processor 112 determines that the batteries are abnormal according to the electrical parameter information of the batteries, the processor 112 can control the display device to display warning messages. The electrical parameter information of the batteries includes temperatures, lifetimes, remaining powers, currents, voltages, etc., of the batteries. The display device 119 may display the electrical parameter information of batteries B1-B8 individually.

In the present embodiment, by displaying the electrical parameter information of the batteries, the visualization of the electrical parameter information of the batteries is realized, so that the electrical parameter information of the batteries is at a glance. When the AC power is converted to DC power by the adapter and a plurality of charging circuits charge a plurality of batteries by using the DC power first with constant current then with constant voltage, if the first charging interface is connected to the first external device, a part of the DC power is separated from a plurality of charging circuits to charge the first external device, and another AC/DC adapter is not needed. As such, the cost for converting the AC to DC is saved. In some embodiments, while the batteries are being discharged, the batteries can charge the first external device connected to the first charging interface. Additionally, no matter the adapter supplies power to the charging system or the batteries supply power to the charging system, the second charging interface can output 5V voltage and 2 A current to charge the second external device connected to the second charging interface and realize the function of simultaneously charging a plurality of external devices.

In accordance with the present disclosure, there is provided a charging system. FIG. 6 is a structural diagram of another example charging system consistent with embodiments of the present disclosure. Based on the embodiments above, the manner for the processor to control the charging circuit to selectively charge the at least one battery connected to the charging circuit can be one of the following manners.

In a first manner, the processor controls the charging circuits to fully charge each battery of the at least one battery in sequence.

As shown in FIG. 6, charging circuit 1 is electrically connected to battery B1 and battery B2 through switch S1 and switch S2, respectively, charging circuit 2 is electrically connected to battery B3 and battery B4 through switch S3 and switch S4, respectively, charging circuit 3 is electrically connected to battery B5 and battery B6 through switch S5 and switch S6, respectively, and charging circuit 4 is electrically connected to battery B7 and battery B8 through switch S7 and switch S8, respectively.

Taking charging circuit 1 as an example, the processor 112 can control charging circuit 1 to fully charge battery B1 first then fully charge battery B2. In some embodiments, the processor 112 controls switch S1 to close and switch S2 to open for charging circuit 1 to charge battery B1. When battery B1 is fully charged, the processor 112 controls switch S1 to open and switch S2 to close for charging circuit 1 to charge battery B2, and control switch S2 to open after battery B2 is fully charged. The charging methods for the other charging circuits are the same as the charging method for charging circuit 1 and are not described here.

In a second manner, the processor controls the charging circuits to charge each battery of the at least one battery in sequence and detects the remaining power of the charging battery. After the remaining power of each battery of the at least one battery reaches a second remaining power threshold, the processor 112 controls the charging circuits to fully charge each battery of the at least one battery in sequence.

Taking charging circuit 1 as an example, the processor 112 can control charging circuit 1 to first charge battery B1 to 90% of total power capacity, then charge battery B2 to 90% of total power capacity, then charge battery B1 to 100% of total power capacity, and finally charge battery B2 to 100% of total power capacity. For example, the processor 112 controls switch S1 to close and switch S2 to open for charging circuit 1 to charge battery B1. When battery B1 is charged to 90% of total power capacity, the processor 112 controls switch S1 to open and switch S2 to close for charging circuit 1 to charge battery B2. When battery B2 is charged to 90% of total power capacity, the processor 112 controls switch S1 to close and switch S2 to open for charging circuit 1 to charge battery B1 again. When battery B1 is charged to 100% of total power capacity, the processor 112 controls switch S1 to open and switch S2 to close for charging circuit 1 to charge battery B2 again. When battery B2 is charged to 100% of total power capacity, the processor 112 controls switch S2 to open. The charging methods for the other charging circuits are the same as the charging method for charging circuit 1 and are not described here.

The charging speed of the second manner is faster than the charging speed of the first manner.

In the embodiment, by controlling the charging circuits to fully charge each battery or controlling the charging circuits to charge the remaining power of each battery to the preset power and then control the charging circuits to fully charge each battery again, the flexibility for the battery charging is improved.

In accordance with the present disclosure, there is provided a charging method. FIG. 7 is a flowchart of a charging method consistent with embodiments of the present disclosure. The method can be implemented in, e.g., the processor 112, which may be a general-purpose processor or a special purpose processor. As shown in FIG. 7, the method includes the following processes.

At S701, the electrical parameter information of each charging circuit is obtained, and each charging circuit is configured to charge at least one battery.

The processor 112 can obtain the electrical parameter information of the charging circuits in real time. For example, the processor 112 can obtain the electrical parameter information of charging circuit 1, charging circuit 2, charging circuit 3, and charging circuit 4. In some embodiments, the electrical parameter information of the charging circuits includes at least one of the output powers of the charging circuits, the output currents of the charging circuits, or the output voltages of the charging circuits.

At S702, according to the electrical parameter information of the charging circuit, each charging circuit is controlled to selectively charge the at least one battery connected to the charging circuit and/or charge the first external device.

For example, according to the electrical parameter information of charging circuit 1, the processor 112 controls charging circuit 1 to selectively charge at least one battery of battery B1 and battery B2 and/or charge the first external device connected to the first charging interface 111.

In some embodiments, controlling each charging circuit to selectively charge the at least one battery connected to the charging circuit includes controlling the charging circuit to charge the at least one battery first with constant current then with constant voltage. In some embodiments, taking charging circuit 1 as an example, the processor can control charging circuit 1 to charge the at least one of battery B1 or battery B2 with the constant current. When the charging circuit starts to charge the at least one battery, the charging circuit outputs the constant current to charge the at least one battery. For example, when charging circuit 1 starts to charge battery B1, charging circuit 1 charges battery B1 with the constant current to quickly increase the power of battery B1. When the power of battery B1 increases to the preset power, the processor 112 can further control charging circuit 1 to output the constant voltage, i.e., control charging circuit 1 to charge battery B1 with the constant voltage.

According to the electrical parameter information of the charging circuits, controlling each charging circuit to selectively charge the at least one battery connected to the charging circuit and/or charge the first external device includes controlling the charging circuit to charge the other one or more batteries and/or the first external device with the constant current at the same time, when the charging circuit switches from outputting the constant current to outputting the constant voltage. For example, charging circuit 1 charges battery B1 with the constant current first, and when the power of battery B1 increases to the preset power, charging circuit 1 switches to charge battery B1 with the constant voltage. When the charging mode of battery B1 switches from the constant current charging mode to the constant voltage charging mode, the current from charging circuit 1 to battery B1 decreases. The part of the decreased current can be used to charge battery B2, be used to charge the first external device connected to the first charging interface 111, or be used to charge both battery B2 and the first external device connected to the first charging interface 111. In some embodiments, when the charging mode of battery B1 switches from the constant current charging mode to the constant voltage charging mode, the processor 112 can control charging circuit 1 to charge battery B1 with the constant voltage, and at the same time charge battery B2 and/or the first external device connected to the first charging interface 111 with the constant current. When the charging mode of battery B2 switches from the constant current charging mode to the constant voltage charging mode, the current from charging circuit 1 to battery B2 decreases. The part of the decreased current can be used to charge the first external device connected to the first charging interface 111 and also output to charging circuit 2. Charging circuit 2 can combine the saved current from charging circuit 1 and the original current of charging circuit 2 to charge battery B3 and battery B4. The charging method for charging circuit 2 to charge battery B3 and battery B4 is similar to the charging method for charging circuit 1 to charge battery B1 or battery B2 and is not described here. Charging circuit 2 charges battery B3 and battery B4 and at the same time charge the first external device connected to the first charging interface 111. The charging methods for charging circuit 3 and charging circuit 4 are similar to above and are not described here.

In some embodiments, the processor 112 can detect the remaining power of the at least one battery connected to the charging circuit and control the charging circuit to charge the first external device connected to the first charging interface when the at least one battery is fully charged. For example, when charging circuit 1 charges battery B1 and battery B2 with the constant voltage, battery B1 and battery B2 may not be fully charged, and charging circuit 1 still needs to charge battery B1 and battery B2 for a certain time with the constant voltage before battery B1 and battery B2 are fully charged. In this scenario, the processor 112 can detect the remaining powers of battery B1 and battery B2 in real time, when the processor 112 determines that battery B1 and battery B2 are fully charged according to the remaining powers of battery B1 and battery B2, the processor 112 controls charging circuit 1 to charge the first external device connected to the first charging interface 111.

Each charging circuit is electrically connected to the first external device through one first unidirectional device. As shown in FIG. 1, charging circuit 1 is electrically connected to the first charging interface 111 through diode D9, charging circuit 2 is electrically connected to the first charging interface 111 through diode D10, charging circuit 3 is electrically connected to the first charging interface 111 through diode D11, and charging circuit 4 is electrically connected to the first charging interface 111 through diode D12.

Each battery is electrically connected to a battery charging circuit through a first switch. As shown in FIG. 1, battery B1 is electrically connected to charging circuit 1 through switch S1, battery B2 is electrically connected to charging circuit 1 through switch S2, battery B3 is electrically connected to charging circuit 2 through switch S3, battery B4 is electrically connected to charging circuit 2 through switch S4, battery B5 is electrically connected to charging circuit 3 through switch S5, battery B6 is electrically connected to charging circuit 3 through switch S6, battery B7 is electrically connected to charging circuit 4 through switch S7, and battery B8 is electrically connected to charging circuit 4 through switch S8.

Controlling the charging circuit to selectively charge the at least one battery connected to the charging circuit includes controlling the at least one first switch connected to the charging circuit to close for the charging circuit to charge the at least one battery connected to the charging circuit. For example, the processor 112 controls switch S1 to close for charging circuit 1 to charge battery B1.

In the embodiments of the disclosure, by simultaneously charging a plurality of batteries through a plurality of charging circuits, the battery charging time is saved. In some embodiments, the processor of the charging system, controls a plurality of charging circuits to selectively charge a plurality of batteries and/or the external devices according to the electrical parameter information of the charging circuits, so that the charging circuits can charge a plurality of batteries and at the same time can also charge the external devices, e.g., the remote device of the UAV, the photographing device, etc., so that the efficiency of the UAV is improved.

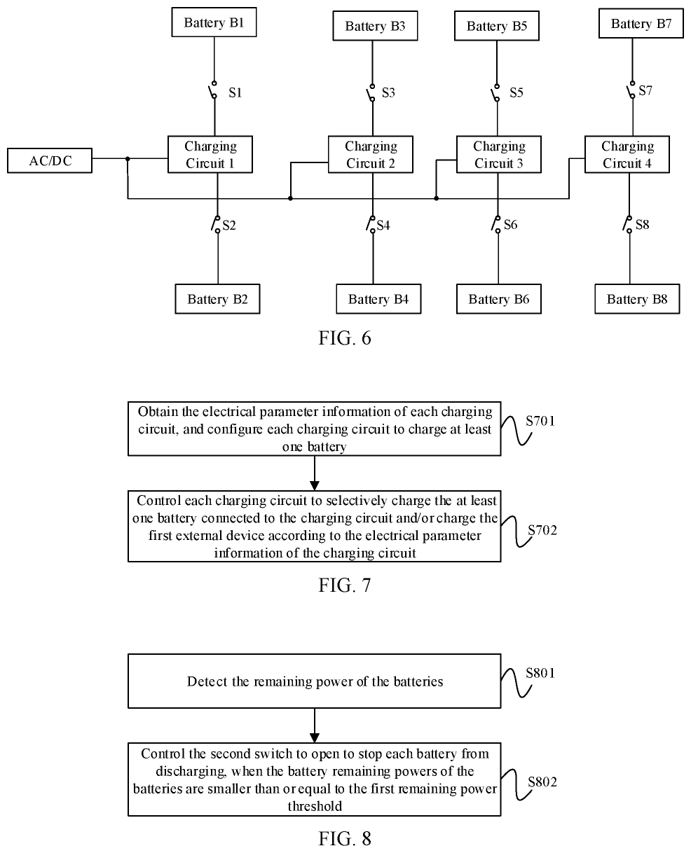

In accordance with the present disclosure, there is provided a charging method. FIG. 8 is a flowchart of another example charging method consistent with embodiments of the present disclosure. Based on the embodiments described above in connection with FIG. 7, each battery is electrically connected to one second unidirectional device and the batteries are connected in parallel through the second unidirectional devices. As shown in FIG. 2, batteries B1-B8 are connected to diodes D1-D8, respectively and diodes D1-D8 connect batteries B1-B8 in parallel.

The positive terminal of each of the batteries is connected to the input terminal of one second unidirectional device, the output terminal of each second unidirectional device is connected to the discharge resistor, and the output terminal of each second unidirectional device is connected to the heat dissipation device. As shown in FIG. 2, the positive terminals of batteries B1-B8 are electrically connected to diodes D1-D8, respectively. The output terminals of diodes D1-D8 are electrically connected to the discharge resistor 115. In addition, the output terminals of diodes D1-D8 are also electrically connected to the heat dissipation device 114. The discharge resistor 115 may be the positive temperature coefficient thermistor. The heat dissipation device 114 may specifically be the fan.

The output terminal of each second unidirectional device is electrically connected to the discharge resistor through the second switch. As shown in FIG. 2, the output terminals of diodes D1-D8 are connected to the discharge resistor 115 through second switch S9. In the present embodiment, the processor 112 can control second switch S9 to close to discharge the batteries through the discharge resistor.

In some embodiments, each battery is discharged through the discharge resistor, and the method consistent with the disclosure further includes the following processes.

At S801, the remaining powers of the batteries is detected.

At S802, the second switch is controlled to open to stop each battery from discharging, when the battery remaining powers of the batteries are smaller than or equal to the first remaining power threshold.

As shown in FIG. 2, when batteries B1-B8 start to be discharged through the discharge resistor 115, the battery with higher voltage is discharged first, and when batteries B1-B8 have the same voltage, batteries B1-B8 are discharged at the same time. While the batteries B1-B8 are being discharged, the processor 112 can also detect the remaining power of each battery. When the remaining power of each battery is smaller than or equal to the remaining power threshold, the processor 112 controls second switch S9 to open to stop batteries B1-B8 from being discharged.

In some embodiments, when each battery is discharged through the discharge resistor, the batteries charge the first external device connected to the first charging interface. As shown in FIG. 2, when batteries B1-B8 are discharged through the discharge resistor 115, the processor 112 further controls one or more switches S1-S8 to close. In some embodiments, the processor 112 controls switches S1-S8 to close. In this scenario, battery B1 and battery B2 will charge the first external device connected to the first charging interface 111 through diode D9, battery B3 and battery B4 will charge the first external device connected to the first charging interface 111 through diode D10, battery B5 and battery B6 will charge the first external device connected to the first charging interface 111 through diode D11, and battery B7 and battery B8 will charge the first external device connected to the first charging interface 111 through diode D12.

In some embodiments, when each battery is discharged through the discharge resistor, each battery supplies power to the heat dissipation device through a second unidirectional device. For example, batteries B1-B8 are discharged through the discharge resistor 115 and at the same time cool the charging system with the fan.

In the present embodiment, by discharging the batteries through the discharge resistor and at the same time controlling the fan to cool the charging system, the cooling power of the charging system is improved and the battery discharging time is reduced, so that the problem of battery being discharged before storage and transportation is solved. In some embodiments, the discharge resistor is a positive temperature coefficient thermistor. The temperature of the positive temperature coefficient thermistor stays stable after the temperature of the positive temperature coefficient thermistor reaches the maximum temperature, and the risk of heat accumulation is prevented. With a plurality of batteries parallelly connected through a plurality of diodes and the parallelly connected batteries discharged through the positive temperature coefficient thermistor, the number of positive temperature coefficient thermistors and the cost are reduced.

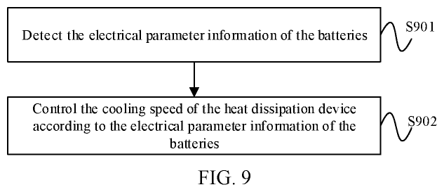

In accordance with the present disclosure, there is provided a charging method. FIG. 9 is a flowchart of another example charging method consistent with embodiments of the present disclosure. Based on the embodiments described in connection with FIG. 8, the method also includes the following processes.

At S901, the electrical parameter information of the batteries is detected.

The processor 112 can obtain the electrical parameter information of each battery in real time, e.g., power, lifetime, temperature, etc., of the battery.

At S902, the cooling speed of the heat dissipation device is controlled according to the electrical parameter information of the batteries.

For example, the processor 112 can control the fan speed according to the battery temperature.

After detecting the electrical parameter information at S901, the method also includes displaying the electrical parameter information of the batteries through the display device.

As shown in FIG. 5, the display device is electrically connected to the processor 112. The display device 119 displays the electrical parameter information of batteries B1-B8 obtained by the processor 112.

In some embodiments, after detecting the electrical parameter information of the batteries at S901, the method also includes determining if the batteries are abnormal according to the electrical parameter information of the batteries and displaying the warning messages through the display device if the batteries are abnormal.

When the processor 112 determines that the batteries are abnormal according to the electrical parameter information of the batteries, the processor 112 controls the display device to display the warning message.

The output terminal of each second unidirectional device is also connected to the second external device. As shown in FIG. 5, the output terminals of diodes D1-D8 are electrically connected to the second charging interface 118 through the first output interface 116, and the second charging interface 118 charges the second external device. The second charging interface 118 may specifically be a two-way USB interface.

While the batteries are being discharged through the discharge resistor, the batteries charge the second external device through the second unidirectional device. For example, batteries B1-B8 are discharged through the discharge resistor 115, at the same time batteries B1-B8 supply power through the first output interface 116. In other words, batteries B1-B8 supply power to the charging system through the first output interface 116. In some embodiments, batteries B1-B8 supply power to DC-to-DC converting (simply denoted as “DC/DC”) circuit 1 through the first output interface 116, DC/DC circuit 1 supplies power to charging circuit 5, and charging circuit 5 further charges the second external device connected to the second charging interface 118.

The charging manner to control the charging circuits to selectively charge the at least one battery connected to the charging circuits can be one of the following manners.

In a first manner, the processor controls the charging circuits to fully charge each battery of the at least one batteries in sequence.

In a second manner, the processor controls the charging circuits to charge each battery and detects the remaining power of the charging battery. After the remaining power of each battery reaches the second remaining power threshold, the processor controls the charging circuits to fully charge each battery in sequence.

The specific principles and implementation manners for the above manners are similar to those in the embodiments described above in connection with FIG. 6 and are not described here.

In the present embodiment, with the electrical parameter information of the batteries displayed through the display device, the visualization of the electrical parameter information of the batteries is realized, so that the electrical parameter information of the batteries is at a glance. In some embodiments, by controlling the charging circuits to fully charge each battery or controlling the charging circuits to charge each battery to the preset power and then controlling the charging circuits to fully charge each battery, the flexibility of the battery charging is improved.

The embodiments of the disclosure, the devices and methods disclosed can be implemented in other forms. For example, the device embodiments described above are merely illustrative. For example, the division of the units is only a logical function division, and the actual implementation may be according to another division method. For example, a plurality of units or components can be combined or integrated in another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate components may be or may not be physically separated, the components displayed as units may be or may not be physical units, which can be in one place or be distributed to a plurality of network units. Some or all of the units can be chosen to implement the purpose of the embodiment according to the actual needs.

In the embodiment of the disclosure, individual functional units can be integrated in one processing unit, or can be individual units physically separated, or two or more units can be integrated in one unit. The integrated units above can be implemented by hardware or can be implemented by hardware and software functional units.

The integrated units implemented by software functional units can be stored in a computer-readable storage medium. The above software functional units stored in a storage medium includes a plurality of instructions for a computing device (such as a personal computer, a server, or network device, etc.) or a processor to execute some of the operations in the embodiments of the disclosure. The storage medium includes USB drive, mobile hard disk, read-only memory (ROM), random access memory (RAM), disk or optical disk, or another medium that can store program codes.

Those skilled in the art can understand that, for convenient and simple description, the division of individual functional modules are described as an example. In actual applications, the functions above can be assigned to different functional modules for implementation, i.e., the internal structure of the device can be divided into different functional modules to implement all or some of the functions described above. For the specific operation process of the device described above, reference can be to the corresponding process in the method embodiments, which will not be described in detail here.

The embodiments are merely used to describe the technical solution of the disclosure but not used to limit the disclosure. Although the disclosure is described in detail referring to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. A charging method comprising:
obtaining electrical parameter information of a charging circuit, the charging circuit being configured to charge one or more batteries of a UAV; and
controlling, according to the electrical parameter information of the charging circuit, the charging circuit to selectively charge the one or more batteries and/or to charge an external device, the external device including at least one of a remote device of the UAV or a photographing device configured to be carried by the UAV.

2. The charging method of claim 1, wherein the electrical parameter information of the charging circuit includes at least one of a power of the charging circuit, an output current of the charging circuit, or an output voltage of the charging circuit.

3. The charging method of claim 1, wherein controlling the charging circuit to selectively charge the one or more batteries includes controlling the charging circuit to charge one of the one or more batteries first with constant current then with constant voltage.

4. The charging method of claim 3, wherein controlling the charging circuit to selectively charge the one or more batteries includes controlling the charging circuit to output the constant current to charge the one of the one or more batteries when the charging circuit starts to charge the one of the one or more batteries.

5. The charging method of claim 3, wherein controlling the charging circuit to selectively charge the one or more batteries and/or to charge the external device includes:
in response to the charging circuit switching from outputting the constant current to outputting the constant voltage, controlling the charging circuit to simultaneously charge another one of the one or more batteries and/or the external device with the constant current.

6. The charging method of claim 1, further comprising:
detecting a remaining power of each of the one or more batteries; and
controlling the charging circuit to charge the external device in response to determining that each of the one or more batteries is fully charged.

7. The charging method of claim 1, wherein the charging circuit is electrically connected to the external device through a unidirectional device.

8. The charging method of claim 1, wherein each of the one or more batteries is electrically connected to the charging circuit through a switch.

9. The charging method of claim 8, wherein controlling the charging circuit to selectively charge the one or more batteries includes:
controlling the switch connected to one of the one or more batteries to close for the charging circuit to charge the one of the one or more batteries.

10. The charging method of claim 1, wherein each of the one or more batteries is connected to a unidirectional device and the one or more batteries are connected in parallel through the one or more unidirectional devices.

11. The charging method of claim 10, wherein:
a positive terminal of each of the one or more batteries is electrically connected to an input terminal of the corresponding unidirectional device;
an output terminal of each of the one or more unidirectional devices is electrically connected to a discharge resistor; and
the discharge resistor is electrically connected to a heat dissipation device.

12. The charging method of claim 11, wherein the output terminal of each of the one or more unidirectional devices is electrically connected to the discharge resistor through a switch.

13. The charging method of claim 12, further comprising:
controlling the switch to close to discharge the one or more batteries through the discharge resistor.

14. The charging method of claim 13, further comprising:
detecting a remaining power of each of the one or more batteries; and
controlling the second switch to open in response to the remaining power of each of the one or more batteries is smaller than or equal to a remaining power threshold.

15. The charging method of claim 13, further comprising:
controlling the one or more batteries to charge the external device when the one or more batteries are being discharged.

16. The charging method of claim 11, further comprising:
controlling the one or more batteries to supply power to the heat dissipation device through the one or more unidirectional devices when the one or more batteries are being discharged.

17. The charging method of claim 16, further comprising:
detecting electrical parameter information of the one or more batteries; and
controlling a cooling speed of the heat dissipation device according to the electrical parameter information of the one or more batteries.

18. The charging method of claim 17, further comprising, after detecting the electrical parameter information of the one or more batteries:
displaying the electrical parameter information of the one or more batteries through a display device.

19. The charging method of claim 17, further comprising, after detecting the electrical parameter information of the one or more batteries:
determining if any of the one or more batteries is abnormal according to the electrical parameter information of the one or more batteries; and
displaying a warning message through the display device in response to determining that any of the one or more batteries is abnormal.

20. A charging method comprising:
obtaining electrical parameter information of a charging circuit, the charging circuit being configured to charge one or more batteries; and
controlling, according to the electrical parameter information of the charging circuit, the charging circuit to selectively charge the one or more batteries and/or to charge an external device.
